(19) United States
(12) Patent Application Publication
(10) Pub. No.: US 2011/0151222 A1
(43) Pub. Date: Jun. 23, 2011

(54) ANTI-REFLECTIVE COATINGS AND METHODS OF MAKING THE SAME

(75) Inventors: Jean-Francois OUDARD, Kingsport, TN (US); François LECOLLEY, Trivieres (BE)

(73) Assignees: AGC FLAT GLASS NORTH AMERICA, INC., Alpharetta, GA (US); ASAHI GLASS CO., LTD., Tokyo (JP); AGC GLASS EUROPE, S.A., Brussels (BE)

(21) Appl. No.: 12/961,137

(22) Filed: Dec. 6, 2010

Related U.S. Application Data
(60) Provisional application No. 61/289,074, filed on Dec. 22, 2009.

(51) Int. Cl. B32B 7/02; B32B 3/26; B05D 5/06

(52) U.S. Cl. 428/216; 428/310.5; 427/162; 427/165

(57) ABSTRACT

The present invention is directed to anti-reflective coatings and methods of making the same. More specifically, the present invention is directed to porosity graded anti-reflective coatings that are made by methods that comprise preparing a liquid composition with specific amounts of tetraethyl orthosilicate, polyethylene glycol, hydrochloric acid, ethanol, butanol and water; applying the liquid composition onto a surface of a heated substrate; and heating the coated glass system to a temperature higher than that of the heated substrate.

### CROSS-REFERENCE TO RELATED APPLICATION

This application claims the benefit of U.S. Provisional Application No. 61/289,074, filed Dec. 22, 2010, which is hereby incorporated by reference in its entirety into the present application.

### FIELD OF THE INVENTION

The present invention relates to anti-reflective coatings. In particular, the present invention relates to anti-reflective coatings that can be used to increase the light transmission of glass used in photovoltaic devices. The present invention also relates to methods of making the anti-reflective coatings.

### BACKGROUND OF THE INVENTION

All United States patents and application Publications referred to herein are incorporated by reference in their entireties. In the case of conflict, the present specification, including definitions, will control.

As the global population continues to grow, so does the demand for energy and energy sources. Fossil fuel consumption has seen steady increases during the last century, as expected for an energy thirsty global population. It was estimated that in 2004, 86% of human-produced energy came from the burning of fossil fuels. Fossil fuels are non-renewable resources and fossil fuel reserves are being depleted quicker than they can be replaced. As a result, a movement toward the development of renewable energy has been undertaken to meet increased demand for energy. Over the last ten to twenty years, there has been an increased focus on developing technology to efficiently harness energy from alternative sources, such as solar, hydrogen and wind energy to meet the increased global demand.

Of the alternative sources, the sun is considered the most abundant natural resource, with an infinite supply of energy showering the Earth on a daily basis. Numerous technologies exist that are directed to capturing the sun's light energy and converting it into electricity. A photovoltaic (PV) module represents such a technology and, to date, has found many applications in areas such as remote power systems, space vehicles and consumer products such as wireless devices.

PV modules are known to incorporate thin films, such as a transparent front conductor, commonly referred to as a transparent conductive thin film or a transparent conductive oxide thin film. Improving the efficiency of PV devices incorporating such thin films typically has been limited by a number of factors. One of these factors is the inherent limitation of light transmission through the PV device, whereby the light transmission is limited by the thin film coatings as well as the other PV device components, such as the PV cover glass. Accordingly, if the light transmission of a PV device can be increased, the probability of a higher electrical conversion efficiency of the PV device may be realized. Hence, the benefits of small improvements in photovoltaic efficiency can accrue over the life of the module and enhance financial return.

PV devices typically include an outer layer of glass, referred to as cover glass. When such modules utilize an outer layer of cover glass, incident light can be reflected away from the PV device due to the difference in the index of refraction between the cover glass and air, leading to a reduction in the amount of incident light available for conversion into electricity. To counteract the reduction in the availability of incident light, it is common to use an anti-reflective coating disposed on the outer surface of the PV cover glass. Such anti-reflective coatings can act to minimize reflection of incident light away from the PV device and maximize light transmission through the cover glass that enters the PV device. Since there is an infinite amount of photons incident upon the Earth on a daily basis, any improvement in light transmission through a PV device is potentially beneficial.

The use of anti-reflective coatings is well-known in the art. Common anti-reflective coatings may be comprised of oxides, oxynitrides and/or oxycarbides of aluminum, tin, zinc, silicon, titanium or any other metal known in the art that can impart anti-reflectivity. Anti-reflective coatings comprising silicon, such as SiO₂ and SiON, are quite common in the art because: 1) the methods of making silicon based anti-reflective coatings are well-known; 2) they are relatively inexpensive to produce; and 3) their chemistry is well understood.

Some success at reducing the reflection in PV cover glass has been achieved by forming low index of refraction coatings of silica on the cover glass. U.S. Pat. No. 7,128,944 discloses low index silica coatings formed by coating the glass with an aqueous coating solution and a surfactant mixture, the aqueous coating solution having a pH of 3 to 8, containing 0.5 wt. % to 5.0 wt. % [SiOₓ(OH)_{y}]ₙ having a particle size of 10 nm to 60 nm, and a surfactant mixture; drying the coated glass; thermal toughening at temperatures of at least 600 C.; and thermal tempering of the coated glass by a forced air flow.

Other low index silica coatings have been formed by dipping a glass substrate in a mixture of tetraethyl orthosilicate and ethanol to form a liquid coating on the glass, or by spraying on the glass a mixture of tetraethyl orthosilicate and ethanol to form a liquid coating; evaporating the ethanol from the liquid coating to form a coating residue; and then heating the coating residue to convert the tetraethyl orthosilicate into silica. Including polyethylene glycol in the liquid coatings has been found to create pores in the silica coatings during the heating that further lowers the index of refraction of the silica and increases light transmission.

However, silica coatings formed using liquid coatings containing tetraethyl orthosilicate, polyethylene glycol and ethanol, while well-known, have not shown a consistent improvement in transmission. Accordingly, there is a need in the art for anti-reflective coatings that achieve improved properties with consistency and methods of preparing such coatings.

### SUMMARY OF THE INVENTION

The present invention provides a method of making an anti-reflective coating that can achieve anti-reflective properties with greater consistency than those currently known in the art. In particular, the present invention provides methods that allow for fast and consistent production of coatings that increase the light transmission through a substrate.

Accordingly, the invention provides an anti-reflective coating with novel features and methods of making the same. The method comprises preparing a layer of silica on a substrate, the method comprising: (i) preparing a composition comprising a starting material comprising Si and O, a polymeric glycol, a strong acid, at least a first alcohol, at least a second alcohol and water; (ii) applying the composition onto a surface of a substrate that is slightly heated to form a coating; and (iii) heating the coated substrate to a higher temperature to form a final coating.

Methods in accordance with the present invention utilize a series of chemical moieties which, when applied to at least one surface of a slightly heated substrate which is then heated to a higher temperature, provide the inventive features described herein. The chemical moieties are preferably starting material compounds that comprise both Si and O, polymeric glycols, strong acids and alcohols. Aqueous solutions of these compounds, when applied to at least one surface of a substrate that is slightly heated and then heated to a higher temperature, allow for the production of a thin film layer of silica that increases the light transmission through a substrate as well as the anti-reflective coating efficiency.

In an aspect of the invention, there is provided a single layer anti-reflective coating and methods of making the same.

In an aspect of the invention, there is provided a double layer anti-reflective coating and methods of making the same.

In an aspect of the invention, there is provided a triple layer anti-reflective coating and methods of making the same.

In another aspect of the invention, there is provided an anti-reflective layer of an anti-reflective coating that is porosity graded throughout the layer thickness, along with methods of making the same.

In another aspect of the invention, there is provided an anti-reflective layer of an anti-reflective coating that is porosity graded such that the larger pores are located closest to the substrate and become smaller throughout the layer thickness away from the substrate, along with methods of making the same.

In another aspect of the invention, there is provided a method of increasing the coating efficiency of an anti-reflective coating.

It has been found that when the reaction mixture comprises more than one alcohol, wherein one alcohol has a higher boiling point than at least one other, a reduction in undesirable evaporation of the solvent during application to at least one surface of a substrate is observed, as described in commonly assigned, copending U.S. patent application Ser. No. 12/045,451. Such undesirable evaporation can increase costs for both materials and cleanup, and can also produce uneven liquid coatings that do not adequately wet the substrate. Thus, having more than one alcohol present in the reaction mixture can enhance the anti-reflective coating efficiency.

### BRIEF DESCRIPTION OF THE DRAWINGS

Illustrative embodiments of the present invention will be described in detail, with reference to the following figures, where:

FIG. 1 shows a single layer anti-reflection coating system in accordance with the present invention.

FIG. 2 shows scanning electron microscope (SEM) photographs of a single layer anti-reflection coating system in accordance with the present invention.

FIG. 3 shows a double layer anti-reflection coating system in accordance with the present invention.

FIG. 4 shows a triple layer anti-reflection coating system in accordance with the present invention.

FIG. 5 shows a light transmission increase diagram for a single layer anti-reflection coating system in accordance with the present invention.

### DETAILED DESCRIPTION OF PREFERRED EMBODIMENTS

While the present invention may be embodied in many different forms, a number of illustrative embodiments are described herein with the understanding that the present disclosure is to be considered as providing examples of the principles of the invention and such examples are not intended to limit the invention to preferred embodiments described and/or illustrated herein. The various embodiments are disclosed with sufficient detail to enable those skilled in the art to practice the invention. It is to be understood that other embodiments may be employed, and that structural and logical changes may be made without departing from the spirit or scope of the present invention.

“Deposited onto” or “deposited on” as used herein means that the substance is directly or indirectly applied above the referenced layer. If applied indirectly, one or more layers may intervene. Furthermore, unless otherwise indicated, in describing coatings of the present invention by use of the format “[substance 1]/[substance 2]/[substance 3]/ . . . ” or the like, it is meant that each successive substance is directly or indirectly deposited onto the preceding substance.

“Transmission” or “light transmission” as used herein means the ratio of the amount of photons passing thru a given substrate to the amount of photons incident upon the given substrate.

“Anti-reflective coating efficiency” as used herein means the increase in light transmission provided by a coating on a given substrate compared to an uncoated given substrate.

“Haze” is defined herein in accordance with ASTM D 1003 which defines haze as that percentage of light which in passing through deviates from the incident beam greater than 2.5 degrees on the average. “Haze” may be measured by methods known to those of skill in this art. Haze data presented herein were measured by a Byk Gardner haze meter (all haze values herein are measured by such a haze meter and are given as a percentage of the incident light that is scattered).

“Reflectance” is a term well understood in the art and is used herein according to its well-known meaning. For example, the term “reflectance” as used herein means the amount of visible, infrared and ultraviolet light that is reflected by a surface relative to the amount that strikes it.

“Absorptance” is a term well understood in the art and is used herein according to its well-known meaning. For example, in a photovoltaic device, absorptance is the ratio of solar energy striking the absorber that is absorbed by the absorber to that of solar energy striking a blackbody (perfect absorber) at the same temperature.

“Refractive index” is a term well understood in the art and is used herein according to its well-known meaning. It is a measure of how much the speed of light (or other waves such as sound waves) is reduced inside a medium. For example, typical soda-lime glass has a refractive index of about 1.5. For a layer that is graded, such as porosity graded as in the present invention, the index of refraction increases or decreases throughout the layer depth. For the graded layers of the present invention, an average value of the index of refraction is given.

The present invention provides an anti-reflective coating and a method of preparing a porosity graded silica layer on a substrate comprising: (i) preparing a starting material composition comprising a compound comprising Si and O, a polymeric glycol, a strong acid, at least a first alcohol, at least a second alcohol and water; (ii) applying the composition onto a surface of a substrate that is slightly heated to form a coating; and (iii) heating the coated substrate to a higher temperature to form a final coating.

More specifically, the present invention provides a method of making an anti-reflective layer, the method comprising preparing a starting material composition comprising 0.1 to 15 volume % of a compound comprising Si and O, 0.1 to 20.0 g of a polymeric glycol per liter of the liquid composition, 0.1 to 20.0 g of a strong acid per liter of the liquid composition, 0.1 to 30 volume % of at least two alcohols, one having a higher boiling point than the other alcohol, and a balance of water; applying the liquid starting material mixture onto a surface of a substrate that is slightly heated to form a coating; and heating the coated substrate to a higher temperature to form the final coating.

The following non-limiting list of compounds are representative of the moieties that may be used in carrying out the methods of the present invention. Compounds comprising Si and O may be silicates, silanols, siloxanes or silanes. Preferred compounds comprising Si and O are silicates. Most preferred compounds comprising Si and O are alkyl-orthosilicates, such as tetraethyl orthosilicate, which is most preferred. Polymeric glycols may be of the polyalkyl, polyalkene or polyalkylene type. Preferred polymeric glycols are polyethylene, polypropylene and polybutylene glycols. The most preferred polymeric glycol is polyethylene glycol. Alcohols may be monohydric and polyols may be dihydric, trihydric, or polyhydric. Preferred alcohols are those of C₁-C₈ alkyl monohydric type. The most preferred alcohol is ethanol. Strong acids may be nitric acid, sulfuric acid, hydrochloric acid and hydrobromic acid. Preferred strong acids are hydrochloric and nitric acids, with hydrochloric acid being the most preferred.

The liquid starting material composition is applied onto at least one surface of a substrate that is preferably transparent to visible light. Substrates to be used in accordance with the present invention are not particularly limited, as long as such substrates are able to allow a large amount of light to pass through (>80% transmittance) and can withstand the high temperatures required by the methods described herein. The substrate can have one or two smooth surfaces. The substrate can also have one or two patterned surfaces. The substrate is preferably a plastic or a ceramic, such as glass. When the substrate is glass, it is preferred that the glass is one of photovoltaic glass or glass with a very low iron, Fe₂O₃, content.

The liquid starting material composition may be applied to the surface of the substrate by spray coating, dip coating, brush coating, spin coating, roll coating, curtain coating, or any other liquid coating application method known to those of skill in the art. Preferably, the liquid starting material composition is sprayed, brushed or spun onto the substrate. Most preferably, the liquid starting material composition is sprayed.

In embodiments of the present invention, when the liquid starting material composition is applied onto the substrate, the substrate may be slightly heated and at atmospheric pressure. In embodiments of the present invention, the substrate is at a temperature of at least about 40° C.-60° C. The alcohols evaporate, leaving a coating comprising a compound comprising Si and O, a polymeric glycol and a strong acid. When the coated substrate is heated to a higher temperature, the strong acid catalyzes the conversion of the compound comprising Si and O into silica, SiO₂. Preferably, the coated substrate is heated to a temperature in a range of from 500 to 800° C., more preferably from 650° C. to 750° C., for a period of time in a range of from 0.5 to 5 minutes, preferably 1 to 3 minutes. During the heating step, the polymeric glycol is pyrolized, or burned away, leaving a porous silica coating. Increasing the porosity of the silica reduces the index of refraction of the silica, leading to improved light transmission through a substrate.

In preferred embodiments, the starting material composition can be prepared by mixing together 0.1 to 10 volume % of a compound comprising Si and O, 0.1 to 15.0 g of a polymeric glycol per liter of the liquid composition, 0.1 to 10.0 g of a strong acid per liter of the liquid composition, 0.1 to 25 volume % of alcohols, one having a higher boiling point than the other, and a balance of water.

In other preferred embodiments, the starting material composition may comprise 0.1 to 5 volume % of a compound comprising Si and O, preferably tetraethyl orthosilicate, 0.1 to 5 volume % of a solution of 30 g polymeric glycol, preferably polyethylene glycol, in 100 ml water, 0.1 to 2 volume % of a solution of 37 weight % strong acid, preferably hydrochloric acid, in water, 0.1 to 20 volume % of alcohols, and a balance of water. The polymeric glycol can have a weight average molecular weight (Mw) in a range of from 4000 to 16000, with a preferable molecular weight of 6000 to 12000.

During the mixing, the ratio of the volume % of the solution of polymeric glycol in 100 ml water to the volume % of the solution containing a compound comprising Si and O can be in a range of from 0.02 to 50. To improve the anti-reflective coating efficiency, the ratio of the volume % of the solution of polymeric glycol in 100 ml water to the volume % of the solution containing a compound comprising Si and O is preferably at least 1; more preferably at least 2.

The inclusion of two alcohols, one having a higher boiling point than the other, acts to reduce undesirable evaporation of solvents (e.g., the alcohols) from droplets during spray application, which can increase costs for both materials and cleanup and which can produce uneven liquid coatings that do not adequately wet the substrate. The alcohol having a higher boiling point also helps to reduce the evaporation rate of the liquid coating, which enhances anti-reflective coating efficiency.

Optionally, a durability enhancing metal oxide may also be included in the starting material composition to impart enhanced durability to the final anti-reflective coating. Oxides of metals that can be used are oxides of aluminum, zinc, tin, titanium, zirconium and mixtures thereof. Also, any other metal oxide that is known to impart enhanced durability can be used. Durability enhancing metal oxides can be included in the anti-reflective layers disclosed herein without significant impact on the optical properties of the anti-reflective layer. Preferred metal oxides for inclusion as durability enhancing components are oxides of aluminum, zirconium, titanium and mixtures thereof with oxides of aluminum, zirconium and mixtures thereof being most preferred.

The aluminum and zirconium starting material to be used in accordance with the present invention is not particularly limited, as long as it is a material that is able to be converted to an oxide of aluminum and zirconium by the processing temperatures required by the present invention. Preferred aluminum starting materials are aluminum acetonates, such as aluminum acetylacetonate, aluminum alkoxides, such as aluminum sec-butoxide, and aluminium alcoholates, such as aluminium tri-sec-butylate. Preferred zirconium starting materials are zirconium acetonates, such as zirconium acetyl acetonate and zirconium alkoxides, such as zirconium isopropoxide, zirconium sec-butoxide, zirconium ethoxide, zirconium isobutoxide, zirconium methoxide, zirconium neo-pentoxide, zirconium propoxide, zirconium butoxide, zirconium tertiary butoxide and zirconium phenoxide.

A preferred range of the durability enhancing metal oxides in the final anti-reflective layer is from about 0.01 weight % to about 10 weight %. A more preferable range is from about 0.05 weight % to about 5 weight %. A most preferred range is from about 0.1 weight % to about 2 weight %. To achieve such weight percentages in the final anti-reflective layer, the metal starting material can be included in the starting material composition in the range of 0.1 g to 10.0 g of metal starting material per liter of composition. A preferred range of metal starting material is from 0.25 g to 5 g per liter of composition.

### I. Single Layer Anti-Reflective Coating System

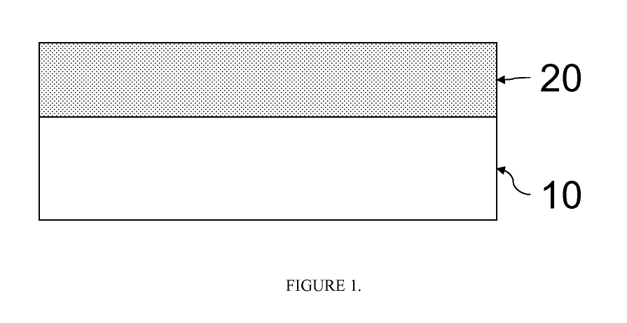

FIG. 1 shows a single layer anti-reflective coating in accordance with the present invention. Substrate 10 is a glass substrate. Disposed on glass substrate 10 is anti-reflective layer 20. In accordance with the present invention, anti-reflective layer 20 is a porous layer of silica, SiO₂, that has a thickness in the range of about 25 nm to about 500 nm. A preferred range of thickness for layer 20 is from about 100 nm to about 400 nm. A most preferred range of thickness for layer 20 is from about 250 nm to about 350 nm. In embodiments of the present invention, the thickness of layer 20 is about 300 nm.

In order to realize anti-reflective properties with the anti-reflective layer 20, it is necessary for the layer 20 to have an average index of refraction that is lower than that of the substrate 10. When substrate 10 is glass, the index of refraction is about 1.50. Accordingly, layer 20 must have an average index of refraction that is below 1.5. A preferred range of average index of refraction values for layer 20 is from about 1.10 to about 1.30. A more preferred range is from about 1.15 to about 1.25. In embodiments of the present invention, anti-reflective layer 20 has an average index of refraction of about 1.20.

Anti-reflective layers made in accordance with methods described herein lead to anti-reflective layer 20 having a high degree of porosity. A representative method is described below.

A liquid composition comprising 0.1 to 15 volume % of tetraethyl orthosilicate, 0.1 to 20.0 g of a polyethylene glycol per liter of the liquid composition, 0.1 to 20.0 g of a hydrochloric acid per liter of the liquid composition, 0.1 to 30 volume % of ethanol and butanol, and a balance of water is prepared. Optionally, the liquid composition may also comprise about 0.1 to about 10.0 g of an aluminum and/or zirconium starting material per liter of liquid composition such that an oxide of aluminum and/or zirconium is included in the final anti-reflective layer 20 to impart enhanced durability to the layer 20. The amount of the oxide of aluminum and/or zirconium included in the final anti-reflective layer is from about 0.1 wt. % to about 10.0 wt %.

The starting material liquid composition is then applied (e.g., sprayed) to a surface of a glass substrate 10 as the glass substrate passes below the spraying mechanism. The glass substrate 10 is slightly heated when the liquid composition is applied. The temperature of the glass substrate 10 is preferably in the range of about 30° C. to about 100° C. A more preferred temperature range of the glass substrate 10 is from about 35° C. to about 75° C. A most preferred temperature range of the glass substrate 10 is from about 40° C. to about 60° C. The coated substrate is passed through a tempering oven whereby the heating of the system to a temperature in the range of about 500° C. to about 800° C. occurs. The tempering/heating step leads to: 1) conversion of the silicon starting materials to silica, SiO₂, which produces the anti-reflective layer 20; 2) conversion of the aluminum and/or zirconium starting materials, if included, to an oxide of aluminum and/or zirconium, respectively; and 3) pyrolyzation of the PEG such that pores are left behind in anti-reflective layer 20 when PEG is pyrolyzed. The tempering/heating step also tempers the glass substrate, which imparts added strength to the glass.

With respect to PEG and the creation of pores in anti-reflective layer 20, the PEG has a weight average molecular weight (Mw) in a range of from about 4,000 to about 16,000. A more preferred range is from about 6,000 to about 12,000. In embodiments in accordance with the present invention, the PEG has a weight average molecular weight from about 7,000 to about 10,000.

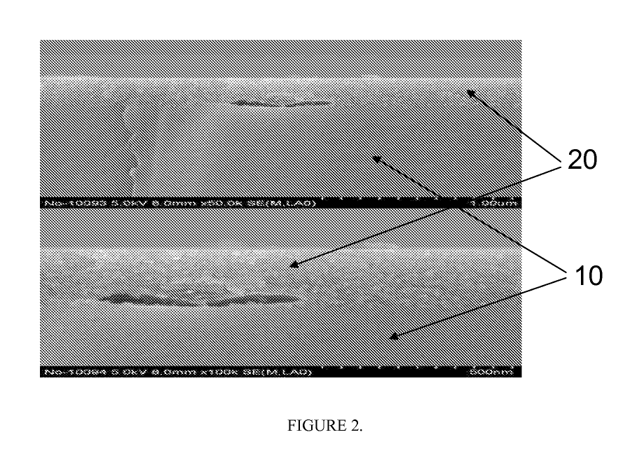

FIG. 2 shows two scanning electron microscope (SEM) photographs of the anti-reflective coating system of FIG. 1. The bottom photograph is an enlarged aspect of the top photograph. The inventor of the subject matter herein has found that not only is anti-reflective layer 20 graded with respect to porosity, but also that the porosity gradient is surprisingly the opposite of what one of skill in the art would expect. In other words, the inventor has surprisingly found that the pore sizes of anti-reflective layer 20 are largest closest to glass substrate 10 and become smaller throughout the thickness of anti-reflective layer 20 away from glass substrate 10. Such a porosity grading of anti-reflective layer 20 is beneficial because the outer surface of the layer becomes more durable when compared to traditional porosity gradings (e.g., smaller pores closest to glass substrate that become larger throughout its thickness away from a glass substrate). This is because large pore sizes are known to weaken, or decrease, the durability of coatings. Thus, having the smaller pores being disposed away from glass substrate 10 strengthens, or increases, the durability of anti-reflective layer 20.

### II. Double Layer Anti-Reflective Coating System

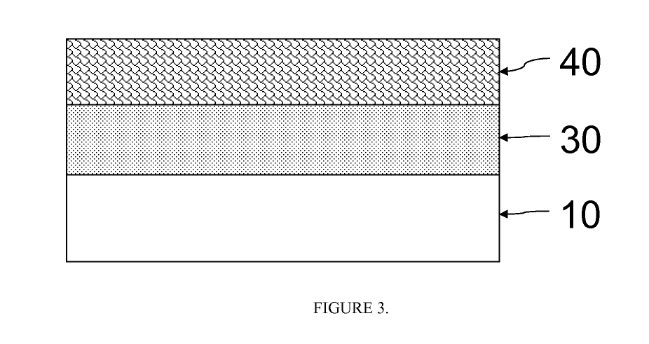

FIG. 3 shows a double layer anti-reflective coating system in accordance with the present invention. Substrate 10 is a glass substrate. Disposed on glass substrate 10 is anti-reflective layer 40 and undercoating layer 30. In accordance with the present invention, anti-reflective layer 40 is a porous layer of silica, SiO₂, that has a thickness in the range of about 50 nm to about 250 nm. A preferred range of thickness for layer 40 is from about 75 nm to about 200 nm. A most preferred range of thickness for layer 40 is from about 80 nm to about 120 nm. In embodiments of the present invention, the thickness of layer 40 is about 100 nm.

Disposed between glass substrate 10 and anti-reflective layer 40 is undercoating layer 30. In accordance with the present invention, undercoating layer 30 is a non-porous layer of silica, SiO₂, that has a thickness in the range of about 50 nm to about 250 nm. A preferred range of thickness for layer 30 is from about 75 nm to about 200 nm. A most preferred range of thickness for layer 30 is from about 80 nm to about 120 nm. In embodiments of the present invention, the thickness of layer 30 is about 100 nm. To make non-porous undercoat layer 30, the methods described above for the single layer anti-reflective coating system can be used with the caveat that the PEG is removed from the process.

In order to realize anti-reflective properties with the double layer anti-reflective coating system of FIG. 3, it is necessary for the layers 30 and 40 to have an index of refraction and average index of refraction, respectively, that is lower than that of the substrate 10. When substrate 10 is glass, the index of refraction is about 1.50. Accordingly, layers 30 and 40 must have an index of refraction and average index of refraction, respectively, that is below 1.5. A preferred range of average index of refraction values for layer 40 is from about 1.25 to about 1.40. A more preferred range is from about 1.25 to about 1.35. In embodiments of the present invention, anti-reflective layer 40 has an average index of refraction of about 1.30. A preferred range of index of refraction values for layer 30 is from about 1.35 to about 1.55. A more preferred range is from about 1.40 to about 1.50. In embodiments of the present invention, layer 30 has an index of refraction of about 1.45.

Anti-reflective layers made in accordance with methods described herein lead to anti-reflective layer 40 having a high degree of porosity. A representative method is described below.

### UnderCoat Layer 30

A liquid composition comprising 0.1 to 15 volume % of tetraethyl orthosilicate, 0.1 to 20.0 g of a hydrochloric acid per liter of the liquid composition, 0.1 to 30 volume % of ethanol and butanol, and a balance of water is prepared. The starting material liquid composition is then applied (e.g., sprayed) to a surface of a glass substrate 10 as the glass substrate passes below the spraying mechanism. The glass substrate 10 may be slightly heated when the liquid composition is applied. The temperature of the glass substrate 10 is preferably in the range of about 20° C. to about 100° C. A more preferred temperature range of the glass substrate 10 is from about 20° C. to about 50° C. A most preferred temperature range of the glass substrate 10 is from about 20° C. to about 40° C. The glass substrate with undercoating starting materials deposited thereon is then passed under another spray coater, whereby the starting materials for anti-reflective layer 40 are applied thereto, as described below.

### Anti-Reflective Layer 40

A liquid composition comprising 0.1 to 15 volume % of tetraethyl orthosilicate, 0.1 to 20.0 g of a polyethylene glycol per liter of the liquid composition, 0.1 to 20.0 g of a hydrochloric acid per liter of the liquid composition, 0.1 to 30 volume % of ethanol and butanol, and a balance of water is prepared. Optionally, the liquid composition may also comprise about 0.1 to about 10.0 g of an aluminum and/or zirconium starting material per liter of liquid composition such that an oxide of aluminum and/or zirconium is included in the final anti-reflective layer 40 to impart enhanced durability to the layer 40. The starting material liquid composition is then applied (e.g., sprayed) to a surface of a glass substrate 10 that has the undercoating layer 30 starting materials deposited thereon. The glass substrate 10 is slightly heated when the liquid composition is applied. The temperature of the glass substrate 10 is preferably in the range of about 30° C. to about 100° C. A more preferred temperature range of the glass substrate 10 is from about 35° C. to about 75° C. A most preferred temperature range of the glass substrate 10 is from about 40° C. to about 60° C. The coated substrate is passed through a tempering oven whereby the heating of the system to a temperature in the range of about 500° C. to about 800° C. occurs. The tempering/heating step leads to: 1) conversion of the silicon starting materials to silica, SiO₂, which produces the anti-reflective layer 40; 2) conversion of the aluminum and/or zirconium starting materials, if included, to an oxide of aluminum and/or zirconium, respectively; and 3) pyrolyzation of the PEG such that pores are left behind in anti-reflective layer 40 when PEG is pyrolyzed. The tempering/heating step also tempers the glass substrate, which imparts added strength to the glass.

With respect to PEG and the creation of pores in anti-reflective layer 40, the PEG has a weight average molecular weight (Mw) in a range of from about 4,000 to about 16,000. A more preferred range is from about 6,000 to about 12,000. In embodiments in accordance with the present invention, the PEG has a weight average molecular weight from about 7,000 to about 10,000.

### III. Triple Layer Anti-Reflective Coating System

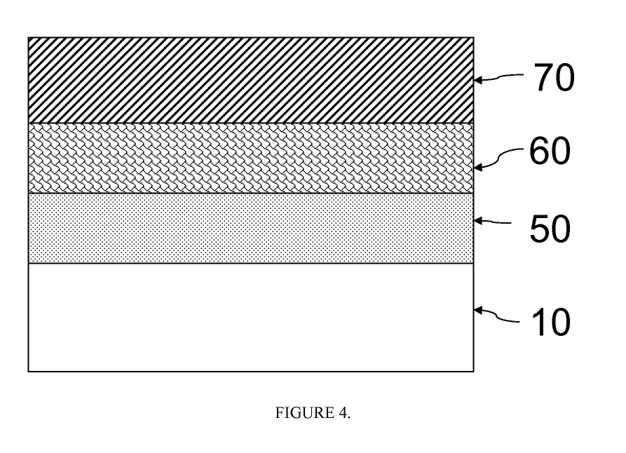

FIG. 4 shows a triple layer anti-reflective coating system in accordance with the present invention. Substrate 10 is a glass substrate. Disposed on glass substrate 10 is anti-reflective layer 70, an additional anti-reflective layer 60 and undercoating layer 50. In accordance with the present invention, anti-reflective layers 70 and 60 are porous layers of silica, SiO₂, that each have a thickness in the range of about 20 nm to about 100 nm. A preferred range of thickness for anti-reflective layers 70 and 60 are from about 30 nm to about 80 nm. A most preferred range of thickness for anti-reflective layers 70 and 60 is from about 35 nm to about 75 nm. In embodiments of the present invention, the thickness of anti-reflective layers 70 and 60 are 40 nm and about 65 nm, respectively.

Disposed between glass substrate 10 and anti-reflective layers 70 and 60 is undercoating layer 50. In accordance with the present invention, undercoating layer 50 is a non-porous layer of silica, SiO₂, that has a thickness in the range of about 50 nm to about 250 nm. A preferred range of thickness for layer 50 is from about 75 nm to about 200 nm. A most preferred range of thickness for layer 50 is from about 80 nm to about 120 nm. In embodiments of the present invention, the thickness of layer 50 is about 100 nm. To make non-porous undercoat layer 50, the methods described above with respect to the non-porous silica layer for the double layer anti-reflective coating system can be used.

In order to realize anti-reflective properties with the triple layer anti-reflective coating system of FIG. 4, it is necessary for the layers 70, 60 and 50 to have an index of refraction and average index of refraction, respectively, that is lower than that of the substrate 10. When substrate 10 is glass, the index of refraction is about 1.50. Accordingly, layers 70, 60 and 50 must have an index of refraction and average index of refraction, respectively, that is below 1.5. A preferred range of average index of refraction values for layer 70 is from about 1.25 to about 1.40. A more preferred range is from about 1.25 to about 1.35. In embodiments of the present invention, anti-reflective layer 70 has an average index of refraction of about 1.30. A preferred range of average index of refraction values for layer 60 is from about 1.10 to about 1.30. A more preferred range is from about 1.15 to about 1.25. In embodiments of the present invention, anti-reflective layer 60 has an average index of refraction of about 1.20. A preferred range of index of refraction values for layer 50 is from about 1.35 to about 1.55. A more preferred range is from about 1.40 to about 1.50. In embodiments of the present invention, layer 50 has an index of refraction of about 1.45.

Anti-reflective layers made in accordance with methods described herein lead to anti-reflective layers 70 and 60 having a high degree of porosity. A representative method is described below.

### UnderCoat Layer 50

A liquid composition comprising 0.1 to 15 volume % of tetraethyl orthosilicate, 0.1 to 20.0 g of a hydrochloric acid per liter of the liquid composition, 0.1 to 30 volume % of ethanol and butanol, and a balance of water is prepared. The starting material liquid composition is then applied (e.g., sprayed) to a surface of a glass substrate 10 as the glass substrate passes below the spraying mechanism. The glass substrate 10 may be slightly heated when the liquid composition is applied. The temperature of the glass substrate 10 is preferably in the range of about 20° C. to about 100° C. A more preferred temperature range of the glass substrate 10 is from about 20° C. to about 50° C. A most preferred temperature range of the glass substrate 10 is from about 20° C. to about 40° C. The glass substrate with undercoating starting materials deposited thereon is then passed under another spray coater, whereby the starting materials for anti-reflective layer 60 are applied thereto, as described below.

### Anti-Reflective Layer 60

A liquid composition comprising 0.1 to 15 volume % of tetraethyl orthosilicate, 0.1 to 20.0 g of a polyethylene glycol per liter of the liquid composition, 0.1 to 20.0 g of a hydrochloric acid per liter of the liquid composition, 0.1 to 30 volume % of ethanol and butanol, and a balance of water is prepared. Optionally, the liquid composition may also comprise about 0.1 to about 10.0 g of an aluminum and/or zirconium starting material per liter of liquid composition such that an oxide of aluminum and/or zirconium is included in the final anti-reflective layer 60 to impart enhanced durability to the layer 60. The starting material liquid composition is then applied (e.g., sprayed) to a surface of a glass substrate 10 that has been treated with the starting materials for undercoating layer 50 as the glass passes below the spraying mechanism. The glass substrate 10 is slightly heated when the liquid composition is applied. The temperature of the glass substrate 10 is preferably in the range of about 30° C. to about 100° C. A more preferred temperature range of the glass substrate 10 is from about 35° C. to about 75° C. A most preferred temperature range of the glass substrate 10 is from about 40° C. to about 60° C.

With respect to PEG and the creation of pores in anti-reflective layer 60, the PEG has a weight average molecular weight (Mw) in a range of from about 4,000 to about 16,000. A more preferred range is from about 6,000 to about 12,000. In embodiments in accordance with the present invention, the PEG has a weight average molecular weight from about 7,000 to about 10,000.

### Anti-Reflective Layer 70

A liquid composition comprising 0.1 to 15 volume % of tetraethyl orthosilicate, 0.1 to 20.0 g of a polyethylene glycol per liter of the liquid composition, 0.1 to 20.0 g of a hydrochloric acid per liter of the liquid composition, 0.1 to 30 volume % of ethanol and butanol, and a balance of water is prepared. Optionally, the liquid composition may also comprise about 0.1 to about 10.0 g of an aluminum and/or zirconium starting material per liter of liquid composition such that an oxide of aluminum and/or zirconium is included in the final anti-reflective layer 70 to impart enhanced durability to the layer 70. The starting material liquid composition is then applied (e.g., sprayed) to a surface of a glass substrate 10 that has the undercoating layer 50 starting materials and the anti-reflective layer 60 starting materials deposited thereon. The glass substrate 10 is slightly heated when the liquid composition is applied. The temperature of the glass substrate 10 is preferably in the range of about 30° C. to about 100° C. A more preferred temperature range of the glass substrate 10 is from about 35° C. to about 75° C. A most preferred temperature range of the glass substrate 10 is from about 40° C. to about 60° C. The system is passed through a tempering oven whereby the heating of the system to a temperature in the range of about 500° C. to about 800° C. occurs. The tempering/heating step leads to: 1) conversion of the silicon starting materials to silica, SiO₂, which produces the anti-reflective layers 70 and 60; 2) conversion of the aluminum and/or zirconium starting materials, if included, to an oxide of aluminum and/or zirconium, respectively; and 3) pyrolyzation of the PEG such that pores are left behind in anti-reflective layers 70 and 60 when PEG is pyrolyzed. The tempering/heating step also tempers the glass substrate, which imparts added strength to the glass.

With respect to PEG and the creation of pores in anti-reflective layer 70, the PEG has a weight average molecular weight (Mw) in a range of from about 4,000 to about 16,000. A more preferred range is from about 6,000 to about 12,000. In embodiments in accordance with the present invention, the PEG has a weight average molecular weight from about 7,000 to about 10,000.

The invention having been generally described, reference is now made to the following examples, which are provided below for purposes of illustration only and are not intended to limit the scope of the invention as defined by the claims.

### Example 1

The following example is a single layer anti-reflective coating intended to be illustrative of the method of the present invention. Other compounds to be used and methods will be recognized and appreciated by those of skill in the art.

The anti-reflective coating described in this Example was made from the method comprising preparing a liquid composition comprising 0.1 to 5.0 volume % of tetraethyl orthosilicate, 0.231 to 11.5 g of polyethylene glycol per liter of the liquid composition, 0.444 to 8.88 g of HCl per liter of the liquid composition, 0.1 to 20 volume % of n-butanol, and a balance of ethanol; applying the liquid composition onto a glass substrate that is at a temperature of 60° C.; and allowing the coated glass substrate to proceed to a tempering oven that is at a temperature of at least about 500° C., whereby the coated glass substrate is heated and the tetraethyl-orthosilicate is converted into silica, SiO₂.

In this Example, the polyethylene glycol had a weight average molecular weight (Mw) in the range of from 4000 to 16000. Assuming that the 30 g polyethylene glycol in 100 ml water has a density of 1 g/ml, the “0.1 to 5 volume % of a solution of 30 g polyethylene glycol in 100 ml” water is approximately equal to the 0.231 to 11.5 g of polyethylene glycol per liter of the liquid composition. Assuming that the solution of 37 weight % HCl in water has a density of 1.2 g/ml, the 0.1 to 2 volume % of a solution of 37 weight % HCl in water is approximately equal to the 0.444 to 8.88 g of HCl per liter of the liquid composition. The solution of 37 weight % HCl in water is commercially available hydrochloric acid known as reagent grade.

During the mixing, the ratio (PEG/TEOS) of the volume % of the solution of 30 g polyethylene glycol in 100 ml water to the volume % of tetraethyl orthosilicate can be in a range of from 0.02 to 50. To improve the anti-reflective coating efficiency, the ration of PEG/TEOS is preferably at least 1; more preferably at least 2. The glass substrate used in this Example was of the low-iron (Fe₂O₃<0.02 wt %) type.

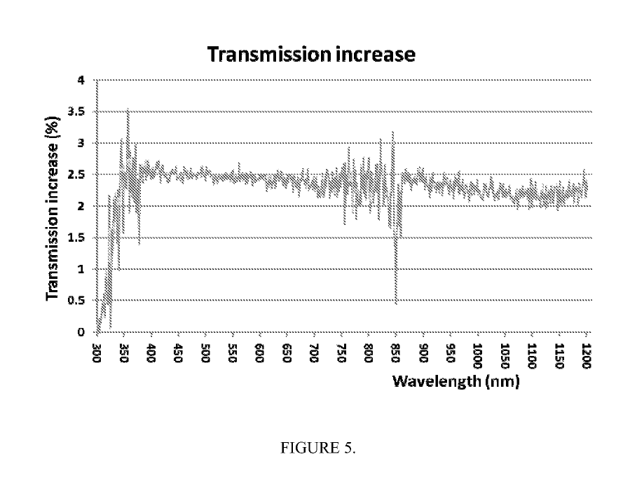

With reference to FIG. 2, it is noted that the single layer anti-reflective coating produced in this Example demonstrates the unexpected properties with respect to the porosity grading, i.e., that the pores sizes are largest closest to the glass substrate and become smaller throughout the layer thickness away from the glass substrate. As previously described above, this feature is unexpected and leads to enhanced durability of the porous SiO₂ coating when compared to traditional porosity graded anti-reflective coatings (e.g., smaller pore sizes closest to the glass substrate). FIG. 5 shows the increase in light transmission for the coated glass substrate made in accordance with Example 1. As can be seen, when compared to an uncoated glass substrate (not shown), the coated glass system of Example 1 leads to a transmission increase in the visible region (380 nm-780 nm) of between about 2.2%-2.5%. We note that these results were taken shortly after the coated glass system of Example 1 was prepared and cooled to room temperature. To get a better sense of the transmission that may be realized after the coated glass system of Example 1 is exposed to environmental conditions for any extended period of time, a number of durability tests were conducted. These durability tests are standard, well-known to those of skill in art and briefly described in Table 1. Table 2 shows light transmission values taken after the durability tests described in Table 1 were carried out on a coated glass system described in Example 1.

TABLE 1
Durability Testing Parameters for Durability Tests Conducted
on a Coated Glass System Described in Example 1.

| Durability Test | Standards | Duration | | Conditions |
|---|---|---|---|---|
| Thermal Cycling | IEC 61215 | 500 | cycles | −40° C./85° C. |
| Test | | | | 3 hours/cycle |
| Damp-Heat Test | IEC 61215 | 1000 | hours | 85° C. |
| | | 1250 | hours | 85% HR |
| Salt Spray Test | EN1096-2 | 500 | hours | 5% aq. NaCl |
| | | | | T = 40° C. |
| Climatic SO₂ Test | EN1096-2 | 20 | cycles | 0.65 vol. % SO₂, |
| | (DIN 50018) | | | T = 40° C. |
| Abrasion | EN1096-2 | 500 | cycles | Rotative Felt |
| | | | | Ø = 14.5 mm − 4N |

TABLE 2
Light Transmission Values After Durability Testing
of a Coated Glass System Described in Example 1.

| Test | Transmission Increase |
|---|---|
| Initial Transmission Increase, 380 nm-780 nm | 2.2%-2.5% |
| (No Testing) | |
| After Abrasion Test | 1.2% |
| After Damp-Heat Test (1000 hours) | 1.9% |
| After Damp-Heat Test (1250 hours) | 1.6% |
| After Thermal Cycling | 1.5% |
| After Salt Spray Test (500 hours) | 0.6% |

The light transmission values for the coated glass system of Example 1 decrease when subjected to certain durability testing as described in Tables 1 and 2 when compared to an untested sample. However, all durability testing from Table 2 shows that the coated glass system of Example 1 still exhibits an overall increase in light transmission. The lowest increase in light transmission was observed from the Salt Spray Test, which increased the light transmission 0.6% when compared to an untested coated glass system of Example 1, while the highest increase in light transmission was observed from the damp-heat, i.e., humidity, tests (1000 hours).

While the present invention has been described with respect to specific embodiments, it is not confined to the specific details set forth, but includes various changes and modifications that may suggest themselves to those skilled in the art, all falling within the scope of the invention as defined by the following claims.

What is claimed is:

1. A coating comprising:
at least one layer disposed over a substrate,
wherein the at least one layer comprises a thickness defined by a first surface and a second surface;
wherein the first surface of the layer is closer to a surface of the substrate than is the second surface; and
wherein the at least one layer is porosity graded such that pores which are larger in size are located closer to the first surface of the layer and the size of pores in the layer becomes smaller throughout the thickness of the layer away from the substrate and toward the second surface.

2. The coating of claim 1, wherein the at least one layer comprises Si.

3. The coating of claim 1, wherein the at least one layer comprises SiO₂.

4. The coating of claim 1, wherein the at least one layer comprises SiO₂ and at least one oxide selected from aluminum, zinc, tin, titanium, zirconium and mixtures thereof.

5. The coating of claim 1, wherein the at least one layer has an average refractive index value of between about 1.10 and about 1.50.

6. The coating of claim 1, wherein the at least one layer has an average refractive index value of between about 1.20 and about 1.40.

7. The coating of claim 1, wherein the at least one layer has a thickness of between about 25 nm and 500 nm.

8. The coating of claim 1, wherein the at least one layer has a thickness of between about 100 nm and 400 nm.

9. The coating of claim 1, wherein the at least one layer has a thickness of between about 250 nm and 350 nm.

10. The coating of claim 1, wherein the substrate is a glass or plastic substrate.

11. The coating of claim 1, wherein the coating comprises at least one additional layer disposed between the porosity graded layer and the substrate.

12. The coating of claim 1, wherein the at least one additional layer disposed between the porosity graded layer and the substrate has a refractive index of between about 1.20 and 1.50.

13. The coating of claim 1, wherein the at least one additional layer disposed between the porosity graded layer and the substrate has a thickness of between about 35 nm and 200 nm.

14. A coating comprising:
a first layer disposed over a substrate;
a second layer disposed over the first layer;
wherein the second layer comprises a thickness defined by a first surface and a second surface;
wherein the first surface of the second layer is closer to a surface of the substrate than is the second surface; and
wherein the second layer is porosity graded such that pores which are larger in size are located closer to the first surface of the second layer and the size of pores in the second layer becomes smaller throughout the thickness of the second layer away from the substrate and toward the second surface.

15. The coating of claim 14, wherein the first layer is non-porous and has a thickness between about 50 nm and 200 nm.

16. The coating of claim 14, wherein the first layer has an index of refraction of between about 1.40 and 1.60.

17. The coating of claim 14, second layer has an average refractive index of between about 1.20 and 1.40.

18. The coating of claim 14, wherein the first and second layers each have a thickness of between about 50 nm and 250 nm.

19. The coating of claim 14, wherein the second layer comprises Si.

20. The coating of claim 14, wherein the second layer comprises SiO₂.

21. The coating of claim 14, wherein the second layer further comprise comprises SiO₂ and at least one oxide selected from aluminum, zinc, tin, titanium, zirconium and mixtures thereof.

22. A method of preparing a coating, the method comprising:
(i) preparing a composition comprising a compound comprising Si and O, a polymeric glycol, a strong acid, at least two alcohols, a balance of water and, optionally, a compound comprising a metal selected from aluminum, zinc, tin, titanium, zirconium, mixtures thereof and O;
(ii) applying the composition onto a surface of a substrate that is slightly heated to a first temperature to form a coating;
(iii) heating the coating to a temperature above the first temperature;
wherein one alcohol has a higher boiling point than the other alcohol.

23. The method according to claim 22, wherein preparing the composition comprises mixing together to form a liquid composition:
1 to 15 volume % of a compound comprising Si and O;
1 to 20 g of a polymeric glycol per liter of composition;
1 to 20 g of strong acid per liter of composition;
1 to 30 volume % of at least two alcohols,
a balance of water; and
optionally, 0.1 to 10 g of a compound comprising Al and O per liter of composition.

24. The method according to claim 22, wherein preparing the composition comprises mixing together to form a liquid composition:
1 to 10 volume % of a compound comprising Si and O;
1 to 15 g of a polymeric glycol per liter of composition;
1 to 15 g of strong acid per liter of composition;
1 to 20 volume % of at least two alcohols;
a balance of water; and
optionally, 0.25 to 5 g of a compound comprising Al and O per liter of composition.

25. The method according to claim 22, wherein the compound comprising Si and O is selected from silanes, silicates, siloxanes or silanols.

26. The method according to claim 25, wherein the compound comprising Si and O is tetraethyl orthosilicate.

27. The method according to claim 22, wherein the polymeric glycol is selected from polyalkyl and polyalkylene glycols.

28. The method according to claim 22, wherein the polymeric glycol is polyethylene glycol.

29. The method according to claim 22, wherein the strong acid is selected from nitric acid, hydrochloric acid, sulfuric acid and hydrobromic acid.

30. The method according to claim 22, wherein the strong acid is hydrochloric acid.

31. The method according to claim 22, wherein at least one of the alcohols is ethanol.

32. The method according to claim 22, wherein when at least one of the alcohols is ethanol, the second alcohol is selected from propanol, butanol and pentanol.

33. The method according to claim 22, wherein when at least one of the alcohols is ethanol, the second alcohol is n-butanol.

34. The method according to claim 22, wherein applying the composition comprises spray coating, dip coating, brush coating, spin coating, roll coating or curtain coating the composition onto at least a surface substrate.

35. The method according to claim 22, wherein applying the composition comprises spray coating the composition onto a substrate.

36. The method according to claim 22, wherein the substrate is a glass or plastic substrate.

37. The method according to claim 22, wherein, during the applying, the substrate is at atmospheric pressure and the first temperature is at a temperature of between about 30° C. and 100° C.

38. The method according to claim 22, wherein, during the applying, the substrate is at atmospheric pressure and the first temperature is at a temperature of between about 35° C. and 75° C.

39. The method according to claim 22, wherein, during the applying, the substrate is at atmospheric pressure and the first temperature is at a temperature of between about 40° C. and 60° C.

40. The method according to claim 22, wherein the temperature above the first temperature is from about 500° C. to about 800° C.

41. The method according to claim 22, wherein the temperature above the first temperature is from about 550° C. to about 750° C.

42. The method according to claim 22, wherein after heating, the coating is porous.

43. The method according to claim 22, wherein after heating, the coating is porosity graded such that larger pores are located closest to the substrate and become smaller throughout the coating thickness away from the substrate.

44. A method of increasing the transmission of light through a substrate, the method comprising:
(i) preparing a composition comprising a compound comprising Si and O, a polymeric glycol, a strong acid, at least two alcohols, a balance of water and, optionally, a metal selected from aluminum, zinc, tin, titanium, zirconium, mixtures thereof and O;
(ii) applying the composition onto a surface of a substrate that is slightly heated to a first temperature to form a coating;
(iii) heating the composition disposed on the substrate to a temperature above the first temperature;
wherein one alcohol has a higher boiling point than the other, and
wherein, after heating, the transmission of light through the substrate with said coating is increased by at least 1.0% when compared to the transmission of light through a substrate without said coating.

45. The coating of claim 1, wherein the at least one layer comprises SiO₂ and at least one oxide selected from aluminum, zirconium and mixtures thereof.

46. The coating of claim 21, wherein the at least one layer comprises SiO₂ and at least one oxide selected from aluminum, zirconium and mixtures thereof.
